(19) United States
(12) Patent Application Publication
(10) Pub. No.: US 2026/0120621 A1
(43) Pub. Date: Apr. 30, 2026

(54) DISPLAY CONTROL CIRCUIT AND DISPLAY DEVICE EMPLOYING CIRCUIT

(71) Applicants: Asphetek Solution (Chengdu) Ltd., Chengdu (CN); Asphetek Solution Inc., Hsinchu (TW)

(72) Inventors: YING-HUNG TSAI, Hsinchu (TW); Yu-Ming Hunag, Hsinchu (TW); Ching-Lin Li, Hsinchu (TW); Yen-Heng Huang, Hsinchu (TW)

(21) Appl. No.: 19/011,866

(22) Filed: Jan. 7, 2025

(30) Foreign Application Priority Data
Oct. 30, 2024 (CN) 202411532861.4

(51) Int. Cl. G09G 3/32

(52) U.S. Cl. CPC G09G 3/32; G09G 2320/0242; G09G 2320/041; G09G 2320/0666; G09G 2330/023

(57) ABSTRACT

A display control circuit for achieving color stability of luminous elements includes: a light emitting module; a temperature detection device configured to detect an operating temperature of the light emitting module; and a control circuit coupled to the light emitting module and the temperature detection device. The control circuit is configured to output driving signals, the driving signals are configured to drive the light emitting module to emit light. The control circuit is further configured to adjust the driving signals according to the operating temperature. When the operating temperature is greater than a preset temperature, a current of the driving signals is positively correlated with the operating temperature. A display device is also provided.

### TECHNICAL FIELD

The subject matter herein generally relates to display technologies.

### BACKGROUND

Light emitting diode (LED) chip can be used in a display device to realize image display. The LED chip has advantages of high color gamut, high brightness, long life, energy saving, and environmental protection, color adjustable, etc. The LED chip of high color gamut can be used in televisions, mobile phones, tablets, and other electronic products, to make a screen color of the electronic product being high vivid and high color reproduction.

The LED chip may exhibit unstable luminous color during operation. Therefore, there is a room for improve the unstable luminous color of the LED chip.

### BRIEF DESCRIPTION OF THE DRAWINGS

Implementations of the present disclosure will now be described, by way of embodiments, with reference to the attached figures.

FIG. 1 illustrates a chromaticity diagram in a prior art.

FIG. 2 is a block diagram illustrating a display control circuit according to an embodiment of the present disclosure.

FIG. 3 is a diagram illustrating a first changing of color coordinates of the blue-green light chip with a temperature according to an embodiment of the present disclosure.

FIG. 4 is a diagram illustrating a second changing of color coordinates of the blue-green light chip with a current according to an embodiment of the present disclosure.

FIG. 5 is a circuit diagram illustrating the display control circuit according to an embodiment of the present disclosure.

FIG. 6 is a circuit diagram illustrating the display control circuit according to another embodiment of the present disclosure.

FIG. 7 is a circuit diagram illustrating the display control circuit according to yet another embodiment of the present disclosure.

FIG. 8 is a block diagram illustrating a display device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected. The term “comprising,” when utilized, means “including, but not necessarily limited to”; it specifically indicates open-ended inclusion or membership in the so-described combination, group, series, and the like.

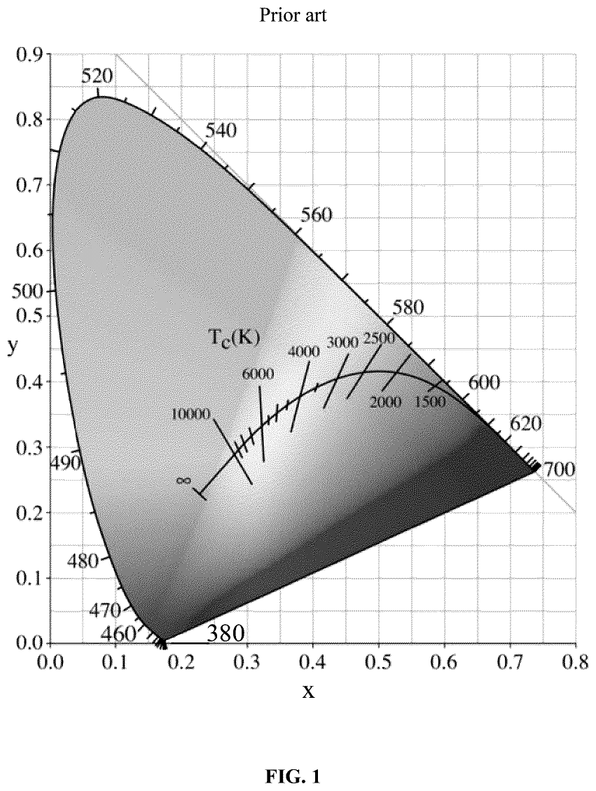

Light emitting diode (LED) chip can use different luminescent materials to emit different colors of light. Because of psychological and physiological effects, color senses of people are not be exactly the same, even the human eye with normal vision. As shown in FIG. 1, a chromaticity diagram can be used to describe luminous colors.

In one embodiment, an operating temperature of the LED chip may affect the luminous color of the LED chip. When the operating temperature of the LED chip is increased, x and y coordinates of the LED chip in the chromaticity diagram may offset, resulting in a deviation of luminous color of the LED chip.

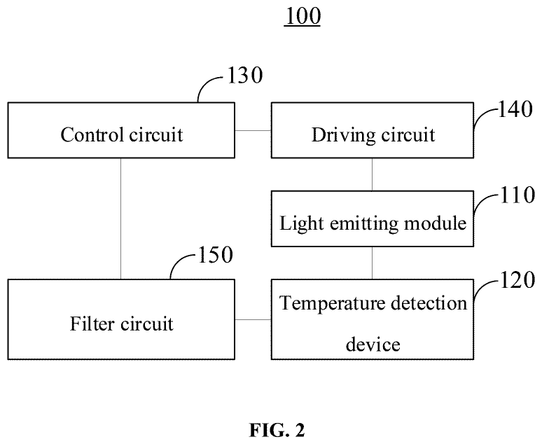

FIG. 2 illustrates one exemplary embodiment of a display control circuit 100.

The display control circuit 100 may include a light emitting module 110, a temperature detection device 120, and a control circuit 130. The temperature detection device 120 is configured to detect an operating temperature of the light emitting module 110. The control circuit 130 is coupled to the light emitting module 110 and the temperature detection device 120, and the control circuit 130 is configured to output driving signals. The driving signals are configured to drive the light emitting module 110 to emit light, and the control circuit 130 is further configured to adjust the driving signals according to the operating temperature of the light emitting module 110. When the operating temperature of the light emitting module 110 is greater than a preset temperature, a current of the driving signals is positively correlated with the operating temperature of the light emitting module 110.

In one embodiment, when the operating temperature of the light emitting module 110 is not greater than the preset temperature, the current of the driving signals can be maintained in a preset value.

In one embodiment, the preset temperature can be set according an actual light-emitting situation of the light emitting module 110. The control circuit 130 adjusting the driving signals may include adjusting a current of the driving signals.

In one embodiment, the temperature detection device 120 may include one or more temperature sensors. The temperature detection device 120 can be arranged close to the light emitting module 110. The control circuit 130 may include a microcontroller unit (MCU), a field-programmable gate array (FPGA), or other chips with control functions. The driving signals can be pulse width modulation (PWM) signals or pulse amplitude modulation (PAM) signals.

The light emitting module 110 may generate heat to increase an environment temperature during an operation state, and the light emitting module 110 may also operate in an environment of high temperature. Then, the operating temperature of the light emitting module 110 may be greater than the preset temperature. When the operating temperature of the light emitting module 110 is greater than the preset temperature, color coordinates of luminous color of the light emitting module 110 may be offset.

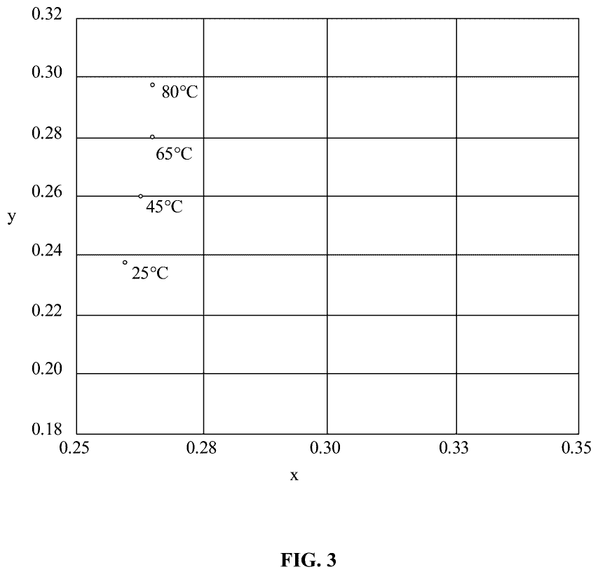

As shown in FIG. 3, taking the light emitting module 110 including blue-green light chips as an example, when a temperature increases from 25° to 80°, a x-coordinate of color coordinates may fluctuate within a small range, and a y-coordinate of the color coordinates may upwardly offset. The color coordinates may offset from a first area near a blue area to a second area near a green area, resulting in a deviation of luminous color of the light emitting module 110.

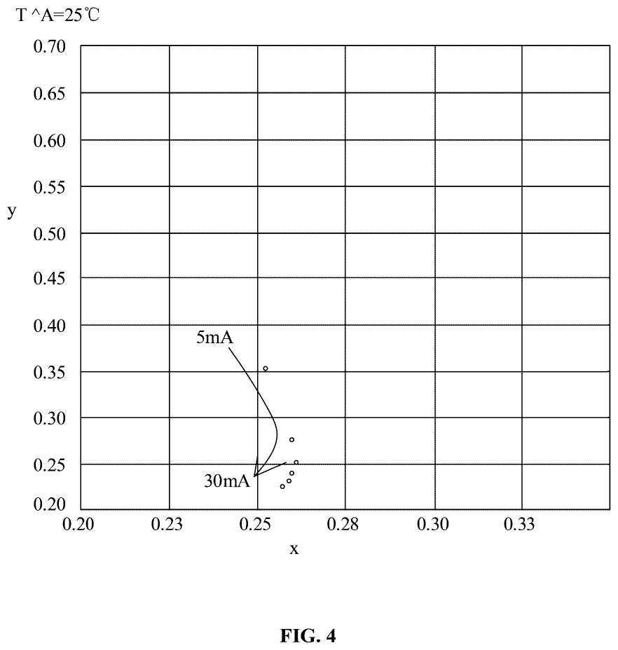

In one embodiment, the current of the driving signals may also affect the luminous color of the light emitting module 110. As shown in FIG. 4, taking the light emitting module 110 including blue-green light chips as an example, when the current of the driving signals increases from 5 mA to 30 mA, the x-coordinate of the color coordinates may fluctuate within a small range, and the y-coordinate of the color coordinates may downwardly offset. By an opposite effect between temperature increasing and current increasing on the y-coordinate of the color coordinates, the control circuit 130 can correct the y-coordinate of the color coordinates according to the operating temperature of the light emitting module 110. For example, the control circuit 130 can correct the y-coordinate of the color coordinates by increasing the current of the driving signals with an increasing of the operating temperature.

For example, when the operating temperature increases from 25° to 45°, the y-coordinate of the color coordinates is upwardly offset, and the current of the driving signals can be increased from 5 mA to 10 mA, causing the y-coordinate of the color coordinates being upwardly offset, to realize correcting the y-coordinate of the color coordinates.

In one embodiment, the control circuit 130 is configured to adjust the driving signals based on a preset temperature-current mapping table. The preset temperature-current mapping table may include different currents of the driving signals corresponding to different operating temperatures.

In one embodiment, the preset temperature-current mapping table can be obtained by testing the light emitting module 110, and the preset temperature-current mapping table can be pre-stored in the control circuit 130, or can be pre-stored in a memory than can be communicated with the control circuit 130. At multiple objective operating temperatures (each of the multiple objective operating temperatures is greater than the preset temperature), an appropriate current of the driving signals can be determined by testing the light emitting module 110, to correct the deviation of luminous color of the light emitting module 110 caused by operating temperature increasing.

In one embodiment, a ratio between the current of the driving signals and the operating temperature can be determined according to an actual test data. Taking the light emitting module 110 including blue-green light chips as an example, when the operating temperature is greater than the preset temperature, a change value of the y coordinate of the color coordinates is about −0.01/10°. As the current of the driving signals increases, a change value of the y-coordinate of the color coordinates is 0.01/5 mA. Such that the control circuit 130 can adjust the driving signals according to an increasing of 5 mA in the current of the driving signals for every 10° increasing in the operating temperature.

In one embodiment, the number of the light emitting module 110 can be one or more. The control circuit 130 can output multiple-channel driving signals to drive multiple light emitting modules 110 or correct deviations of luminous color of the multiple light emitting module 110, each of the multiple light emitting modules 110 corresponds to one channel driving signals.

In one embodiment, the control circuit 130 may output single-channel driving signals to drive the multiple light emitting modules 110 or correct deviations of luminous color of the multiple light emitting module 110.

In one embodiment, the light emitting module 110 may include one or more light emitting elements 111. The light-emitting element 111 can be a blue light chip, a green light chip, or a blue-green light chip.

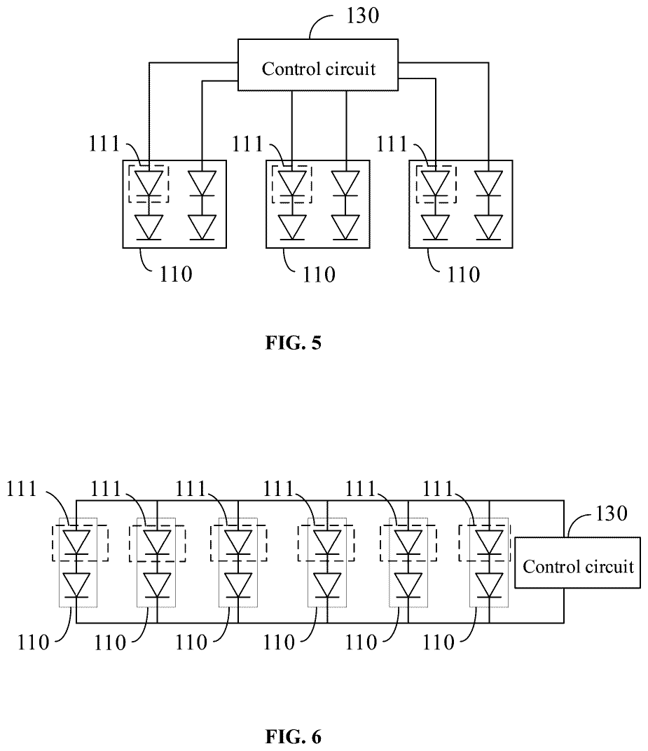

Referring to FIG. 5, the display control circuit 100 includes multiple light emitting modules 110, each of the multiple light emitting modules 110 includes one or more light emitting elements 111. The multiple light emitting modules 110 are coupled to the control circuit 130, and the control circuit 130 is configured to output multiple-channel driving signals. Each of the multiple-channel driving signals is configured to drive one of the multiple light emitting modules 110 to emit light.

The control circuit 130 outputs the multiple-channel driving signals to respectively control the multiple light emitting modules 110 to achieve accurate adjustment of each of the multiple light emitting modules 110. For example, when the types of light emitting elements 111 in the multiple light emitting module 110 are different, the control circuit 130 can adjust corresponding driving signals according to luminescence characteristics of different types of light emitting elements 111.

In one embodiment, the number of the temperature detection device 120 can be set according to the number of the light emitting module 110. For example, one temperature detection device 120 corresponds to one light emitting module 110. Light emitting elements 111 in each of the multiple light emitting modules 110 can include blue light chips, green light chips, or blue-green light chips.

Referring to FIG. 6, the display control circuit 100 includes multiple light emitting modules 110, each of the multiple light emitting modules 110 includes one or more light emitting elements 111. The multiple light emitting modules 110 are coupled to the control circuit 130, and the control circuit 130 is configured to output single-channel driving signals, the single-channel driving signals are configured to drive the plurality of light emitting modules to emit light. Such that the multiple light emitting modules 110 correspond to the same driving signals.

The control circuit 130 can simultaneously adjust the multiple light emitting modules 110 based on the single-channel driving signals. In this way, a circuit layout can be simplified. Light emitting elements 111 in each of the multiple light emitting modules 110 can include blue light chips, green light chips, or blue-green light chips.

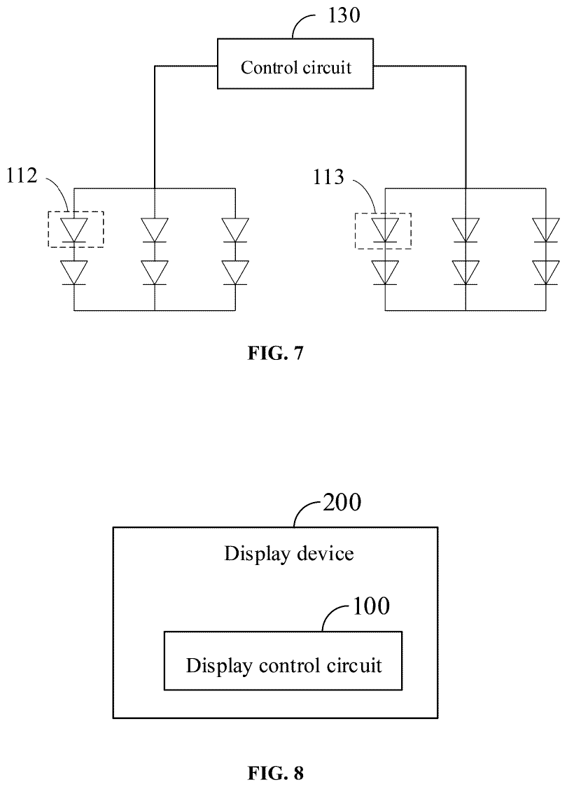

Referring to FIG. 7, the light emitting module 110 may include a plurality of first light emitting elements 112 and a plurality of second light emitting elements 113. A type of the plurality of first light emitting elements 112 is different from a type of the plurality of second light emitting elements 113. The control circuit 130 is coupled to the plurality of first light emitting elements 112 and the plurality of second light emitting elements 113, the control circuit 130 is configured to output first driving signals and second driving signals. The first driving signals are configured to drive the plurality of first light emitting elements 112 to emit light, and the second driving signals are configured to drive the plurality of second light emitting elements 113 to emit light. The control circuit 130 is further configured to adjust the first driving signals and the second driving signals according to the operating temperature of the light emitting module 110. Each of a current of the first driving signals and a current of the second driving signals is positively correlated with the operating temperature of the light emitting module 110.

Driving voltage of different types of light emitting elements 111 may be different, and the control circuit 130 can respectively output the first driving signals and the second driving signals to drive the first light emitting elements 112 and the second light emitting elements 113. The first light emitting elements 112 and the second light emitting elements 113 can be respectively drove to emit appropriate color light. The control circuit 130 can respectively adjust the first driving signals and the second driving signals according to luminescence characteristics of the first light emitting elements 112 and the second light emitting elements 113, to achieve accurate adjustment of the first light emitting elements 112 and the second light emitting elements 113.

In one embodiment, the first light emitting elements 112 and the second light emitting elements 113 can be blue light chips, green light chips, or blue-green light chip. The number of the temperature detection device 120 can be set to two or more, to respectively detect a first operating temperature of the first light emitting elements 112 and a second operating temperature of the second light emitting elements 113, so that the control circuit 130 can accurately adjust the first driving signals and the second driving signals.

In one embodiment, the display control circuit 100 may further include a driving circuit 140, the driving circuit 140 is coupled to the light emitting module 110 and the control circuit 130. The driving circuit 140 is configured to output the driving signals according to control signals outputted by the display controller 130.

In one embodiment, the driving circuit 140 may include triodes/metal oxide semiconductor (MOS) transistors, rectifier bridges, resistors, capacitors, etc., to realize driving function. The control signals can be PAM signals or PWM signals. The control circuit 130 can adjust a duty cycle of the control signals to realize the adjustment of the driving signals.

In one embodiment, the display control circuit 100 may further include a filter circuit 150, the filter circuit 150 is coupled to the temperature detection device 120 and the control circuit 130. The filter circuit 150 is configured to filter detection signals outputted by the temperature detection device 120 and output filtered detection signals to the control circuit 130.

In one embodiment, the filter circuit 150 may include capacitors and resistors to realize filtering function. The filter circuit 150 filters the detection signals outputted by the temperature detection device 120, so that the control circuit 130 can receive accurate detection signals, to accurately adjust the driving signals.

In one embodiment, the control circuit 130 can collect the detection signals output by the temperature detection device 120 at a preset time interval, and determine the current operating temperature of the light emitting module 110 according to a voltage of the detection signals.

In one embodiment, the preset interval can be set according to an actual application, for example, the preset interval can be set to 3 minutes, 5 minutes, etc. In this way, the operating temperature of the light emitting module 110 can be detected in time, and a power consumption of detection can be reduced.

The embodiment detects the operating temperature of the light emitting module 110 by the temperature detection device 120, and adjusts the driving signals according to the operating temperature of the light emitting module 110, so that the current of the driving signals increases with the increasing of the operating temperature, to correct a color deviation caused by the temperature rising of the light emitting module 110. A luminous color of the light emitting module 110 can be stable, and an operation reliability of the light emitting module 110 can be improved.

Referring to FIG. 8, a display device 200 is provided. The display device 200 includes a display control circuit 100. The display device can be a TV screen, a computer monitor, a mobile phone screen, etc.

In one embodiments, comparing with FIG. 8, the display device 200 can include more or less elements, for example, the display device 200 may further include a power supply circuit, a display control card, etc.

A structure of the display control circuit 100 can be referred to the above embodiments. It can be understood that the display control circuit 100 is used in the display device of the embodiment, the display device 200 include all technical schemes of the above embodiments of the display control circuit 100, and technical effects achieved are the same, so the structure of the display control circuit 100 is not repeat here.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A display control circuit comprising:
a light emitting module comprising one or more light emitting elements;
a temperature detection device configured to detect an operating temperature of the light emitting module; and
a control circuit coupled to the light emitting module and the temperature detection device, and configured to output driving signals,
wherein the driving signals are configured to drive the light emitting module to emit light; the control circuit is further configured to adjust the driving signals according to the operating temperature detected by the temperature detection device; and when the operating temperature is greater than a preset temperature, a current of the driving signals is positively correlated with the operating temperature, and each of the one or more light emitting elements comprises a blue light chip, a green light chip, or a blue-green light chip.

2. The display control circuit of claim 1, wherein the control circuit comprises a preset temperature-current mapping table, the control circuit is further configured to adjust the driving signals based on a preset temperature-current mapping table; and the preset temperature-current mapping table comprises different currents of the driving signals corresponding to different operating temperatures.

3. The display control circuit of claim 1, wherein the display control circuit comprises at least one light emitting module.

4. The display control circuit of claim 3, wherein the display control circuit comprises a plurality of light emitting modules, each of the plurality of light emitting modules comprises one or more light emitting elements; the plurality of light emitting modules are coupled to the control circuit; the control circuit is configured to output multiple-channel driving signals, each of the multiple-channel driving signals is configured to drive a corresponding light emitting module of the plurality of light emitting modules to emit light.

5. The display control circuit of claim 3, wherein the display control circuit comprises a plurality of light emitting modules, each of the plurality of light emitting modules comprises one or more light emitting elements; the plurality of light emitting modules are coupled to the control circuit; the control circuit is configured to output single-channel driving signals, the single-channel driving signals are configured to drive the plurality of light emitting modules to emit light.

6. The display control circuit of claim 1, wherein the light emitting module comprises a plurality of first light emitting elements and a plurality of second light emitting elements; a type of the plurality of first light emitting elements is different from a type of the plurality of second light emitting elements; the control circuit is coupled to the plurality of first light emitting elements and the plurality of second light emitting elements; the control circuit is further configured to output first driving signals and second driving signals; the first driving signals are configured to drive the plurality of first light emitting elements, and the second driving signals are configured to drive the plurality of second light emitting elements; the control circuit is further configured to adjust the first driving signals and the second driving signals according to the operating temperature; and each of a current of the first driving signals and a current of the second driving signals is positively correlated with the operating temperature.

7. (canceled)

8. The display control circuit of claim 1, further comprising a driving circuit coupled to the light emitting module and the control circuit, wherein the driving circuit is configured to output the driving signals according to control signals outputted by the control circuit.

9. The display control circuit of claim 1, further comprising a filter circuit coupled to the temperature detection device and the control circuit, wherein the filter circuit is configured to filter detection signals outputted by the temperature detection device and output filtered detection signals to the control circuit.

10. A display device comprising a display control circuit, the display control circuit comprising:
a light emitting module;
a temperature detection device, configured to detect an operating temperature of the light emitting module; and
a control circuit, coupled to the light emitting module and the temperature detection device, and configured to output driving signals;
wherein the driving signals are configured to drive the light emitting module to emit light; the control circuit is further configured to adjust the driving signals according to the operating temperature; and when the operating temperature is greater than a preset temperature, a current of the driving signals is positively correlated with the operating temperature, and each of the one or more light emitting elements comprises a blue light chip, a green light chip, or a blue-green light chip.

11. The display device of claim 10, wherein the control circuit comprises a preset temperature-current mapping table, the control circuit is configured to adjust the driving signals based on a preset temperature-current mapping table; and the preset temperature-current mapping table comprises different currents of the driving signals corresponding to different operating temperatures.

12. The display device of claim 10, wherein the display control circuit comprises one or more light emitting modules.

13. The display device of claim 12, wherein the display control circuit comprises a plurality of light emitting modules, each of the plurality of light emitting modules comprises one or more light emitting elements; the plurality of light emitting modules are coupled to the control circuit; the control circuit is configured to output multiple-channel driving signals, each of the multiple-channel driving signals is configured to drive one of the plurality of light emitting modules to emit light.

14. The display device of claim 12, wherein the display control circuit comprises a plurality of light emitting modules, each of the plurality of light emitting modules comprises one or more light emitting elements; the plurality of light emitting modules are coupled to the control circuit; the control circuit is configured to output single-channel driving signals, the single-channel driving signals are configured to drive the plurality of light emitting modules to emit light.

15. The display device of claim 10, wherein the light emitting module comprises a plurality of first light emitting elements and a plurality of second light emitting elements; a type of the plurality of first light emitting elements is different from a type of the plurality of second light emitting elements; the control circuit is coupled to the plurality of first light emitting elements and the plurality of second light emitting elements; the control circuit is configured to output first driving signals and second driving signals; the first driving signals are configured to drive the plurality of first light emitting elements, and the second driving signals are configured to drive the plurality of second light emitting elements; the control circuit is further configured to adjust the first driving signals and the second driving signals according to the operating temperature; and each of a current of the first driving signals and a current of the second driving signals is positively correlated with the operating temperature.

16. (canceled)

17. The display device of claim 10, wherein the display control circuit further comprises a driving circuit; the driving circuit is coupled to the light emitting module and the control circuit, and the driving circuit is configured to output the driving signals according to control signals outputted by the control circuit.

18. The display device of claim 10, wherein the display control circuit further comprises a filter circuit; the filter circuit is coupled to the temperature detection device and the control circuit, and the filter circuit is configured to filter detection signals outputted by the temperature detection device and output filtered detection signals to the control circuit.
